(19) United States
(12) Patent Application Publication
(10) Pub. No.: US 2019/0194055 A1
(43) Pub. Date: Jun. 27, 2019

(54) METHOD FOR PRODUCING GLASS FILM

(71) Applicant: Nippon Electric Glass Co., Ltd., Shiga (JP)

(72) Inventors: Koichi MORI, Shiga (JP); Koji NISHIJIMA, Shiga (JP); Hiroki MORI, Shiga (JP)

(21) Appl. No.: 16/329,801

(22) PCT Filed: Sep. 21, 2017
(86) PCT No.: PCT/JP2017/034160

§ 371 Date: Mar. 1, 2019

(30) Foreign Application Priority Data
Oct. 11, 2016 (JP) 2016-200033

(51) Int. Cl. C03B 35/18; C03B 17/06; C03B 35/24

(52) U.S. Cl. CPC C03B 35/18; C03B 2225/02; C03B 35/246; C03B 17/062

(57) ABSTRACT

Provided is a method of manufacturing a glass film, including: a forming step of forming a band-shaped glass film (1); a conveyance direction changing step of changing a conveyance direction of the band-shaped glass film (1) from a vertically downward direction to a horizontal direction by conveying the band-shaped glass film (1) along a curved conveyance path (R1); and a horizontal conveyance step of conveying the band-shaped glass film (1) in the horizontal direction along a horizontal conveyance path (R2), wherein, when some sections of the band-shaped glass film (1) are to be discarded, the method involves: a separating step of separating a discard glass part (1x) from the band-shaped glass film (1) on the horizontal conveyance path (R2); and a discarding step of discarding the separated discard glass part (1x) by causing the discard glass part (1x) to leave the horizontal conveyance path (R2) downward.

### TECHNICAL FIELD

The present invention relates to a method of manufacturing a band-shaped glass film by a down-draw method.

### BACKGROUND ART

In recent years, a small thickness and a small weight are demanded for mobile terminals such as smartphones and tablet PCs which are rapidly spread. Thus, in the current condition, there is an increasing demand for reduction in thickness of glass substrates to be incorporated into those terminals. Under such current condition, a glass film which is a glass substrate reduced in thickness as small as that of a film (for example, thickness equal to or smaller than 300 μm) is now developed and manufactured.

Incidentally, steps of manufacturing a glass film generally include a step of manufacturing a band-shaped glass film that is a base of the glass film. In Patent Literature 1, there is disclosed an example of a method of manufacturing a band-shaped glass film through use of a down-draw method as represented by, for example, an overflow down-draw method, a re-draw method, and a slot down-draw method.

The method disclosed in Patent Literature 1 includes a forming step, a conveyance direction changing step, a horizontal conveyance step, a cutting and removing step, and a winding step. In the forming step, a band-shaped glass film is formed while being drawn downward in a vertical direction through use of a forming device. In the conveyance direction changing step, through use of a roller conveyor arranged below the forming device in the vertical direction, the band-shaped glass film having been formed is conveyed along a curved conveyance path, thereby changing the conveyance direction from a vertically downward direction to a horizontal direction. In the horizontal conveyance step, the band-shaped glass film having been changed in conveyance direction is conveyed in the horizontal direction along a horizontal conveyance path. In the cutting and removing step, through use of a laser cutting device, non-effective parts (parts including edge portions each having a large thickness), which are present at both ends in a width direction, are cut and removed from the band-shaped glass film being conveyed in the horizontal direction. In the winding step, the band-shaped glass film having the non-effective parts cut and removed therefrom is wound up around a winding core to be formed into a glass roll.

During manufacturing of the band-shaped glass film through use of the above-mentioned method, in some cases, it is required that some sections along a longitudinal direction be separated from the band-shaped glass film having been formed in the forming step and be discarded as discard glass parts. For example, there are given (A) a case in which, after completion of a glass roll formed by winding a band-shaped glass film having a desired length, a winding core is to be replaced with a new winding core to produce the next glass roll, and (B) a case in which adjustment of a laser cutting device for cutting and removing non-effective parts from the band-shaped glass film is performed.

Specifically, in the case (A) described above, winding of the new band-shaped glass film cannot be started until the replacement of the winding core is completed. Thus, some sections formed during the replacement of the winding core are discarded as discard glass parts. Meanwhile, in the case (B) described above, until the adjustment of the laser cutting device is completed, a band-shaped glass film having the non-effective parts removed therefrom cannot be obtained. That is, a band-shaped glass film in a state of being suitable for winding into a glass roll cannot be obtained, and hence some sections formed during the adjustment of the laser cutting device are discarded as the discard glass parts.

In order to prevent formation of the discard glass part, it is conceivable to take a measure of temporarily stopping forming of the band-shaped glass film during replacement of the winding core or adjustment of the laser cutting device. However, in a case in which such a measure is taken, when forming is restarted, it is extremely difficult to restore forming conditions for the band-shaped glass film to original forming conditions. Therefore, there is adopted a measure of continuously forming the band-shaped glass film and discarding some sections thereof as the discard glass parts also during replacement of the winding core and adjustment of the laser cutting device.

As one example of a mode of discarding the discard glass part, there is given a mode of repeatedly cutting the band-shaped glass film, which is being conveyed downward in the vertical direction after forming, along a width direction to thereby cut out the discard glass part as a large number of discard glass films from the band-shaped glass film and dropping the discard glass films downward in the vertical direction to thereby discard the discard glass films. In this mode, before discarding of the discard glass part is started, the roller conveyor is caused to temporarily retreat from a position vertically below the forming device, and the conveyance direction changing step is temporarily stopped. After the replacement of the winding core or the adjustment of the laser cutting device has been completed, the discarding of the discard glass part is terminated, and the roller conveyor is reinstated to the position vertically below the forming device. A band-shaped glass film subsequent to the discard glass parts is allowed to pass on the roller conveyor (on the curved conveyance path), and the band-shaped glass film is taken into the horizontal conveyance path, thereby restarting the conveyance direction changing step.

### CITATION LIST

Patent Literature 1: JP 2015-44709 A

### SUMMARY OF INVENTION

### Technical Problem

However, in a case in which the discard glass parts are discarded in the mode described above, the following problems that are required to be solved occur.

That is, in the mode described above, along with the discarding of the discard glass parts, it is required to cause the roller conveyor to retreat from the position vertically below the forming device and reinstate, and it is required to allow the band-shaped glass film to pass on the roller conveyor, and take the band-shaped glass film into the horizontal conveyance path. Such operations are extremely complicated. Moreover, the degree of difficulty of the operation of taking the band-shaped glass film into the conveyance path is high, and there has been a problem in that cracks are liable to be formed in the band-shaped glass film during the operation. When the cracks are formed, the cracks may proceed along the longitudinal direction of the band-shaped glass film to reach the part being formed, and may cause a situation in which forming of the band-shaped glass film is inevitably suspended.

Those problems occur not only when the discard glass part is discarded in the mode described above during manufacturing of the band-shaped glass film using the method described above. Besides, in a case in which the band-shaped glass film is to be manufactured in a mode in which the conveyance direction after forming by the down-draw method is changed from the vertically downward direction to the horizontal direction, those problems may similarly occur when the discard glass part is to be discarded in the mode described above.

The present invention has been made in view of the circumstances described above, and has a technical object to achieve, in a case of manufacturing a band-shaped glass film in a mode in which a conveyance direction after forming by the down-draw method is changed from the vertically downward direction to the horizontal direction, simplification in operation for discarding some sections along the longitudinal direction of the band-shaped glass film as a discard glass part and prevention of formation of a crack in the band-shaped glass film at the time of discarding the discard glass part.

### Solution to Problem

According to one embodiment of the present invention, there is provided a method of manufacturing a glass film, comprising: a forming step of forming a band-shaped glass film by drawing the band-shaped glass film downward in a vertical direction by a down-draw method; a conveyance direction changing step of changing a conveyance direction of the band-shaped glass film from a vertically downward direction to a horizontal direction by conveying the formed band-shaped glass film along a curved conveyance path so that a front surface of the band-shaped glass film after having passed through the curved conveyance path faces upward; and a horizontal conveyance step of conveying the band-shaped glass film, which has been changed in conveyance direction, in the horizontal direction along a horizontal conveyance path, wherein, when some sections of the band-shaped glass film along a longitudinal direction are to be discarded as a discard glass part, the method involves: a separating step of separating the discard glass part from the band-shaped glass film by cutting the band-shaped glass film in a width direction on the horizontal conveyance path; and a discarding step of discarding the separated discard glass part by causing the discard glass part to leave the horizontal conveyance path downward.

In this method, the separating step of separating the discard glass part from the band-shaped glass film is performed on the horizontal conveyance path. Therefore, at the time point at which the separating step is performed so that the discard glass part is separated from the band-shaped glass film, a leading portion of a band-shaped glass film subsequent to the discard glass part is already located on the horizontal conveyance path. That is, the subsequent band-shaped glass film is already taken into the horizontal conveyance path. Further, in this method, similarly to the separating step, the discarding step is performed on the horizontal conveyance path, and the discard glass part separated from the band-shaped glass film is discarded. Thus, according to this method, there is no need to take the band-shaped glass film subsequent to the discard glass part into the horizontal conveyance path along with discarding of the discard glass part. As a result, an operation which is related to the discarding of the discard glass part can be simplified. Moreover, there is no need to perform the operation of taking the band-shaped glass film into the horizontal conveyance path, which is highly difficult and is liable to cause cracks during the operation. Thus, formation of the cracks in the band-shaped glass film can also be prevented. Moreover, according to this method, the following supplementary effect can be attained. The discard glass part is caused to leave the horizontal conveyance path downward. Thus, for example, unlike a case in which the discard glass part is caused to leave upward, the situation in which the discard glass part once having left the horizontal conveyance path falls by its own weight to remain on the horizontal conveyance path can be appropriately eliminated.

In the method described above, it is preferred that, in the discarding step, the discard glass part be caused to fall from the horizontal conveyance path.

As a result of the separating step, both of a rearmost portion of the discard glass part separated from the band-shaped glass film and the leading portion of the band-shaped glass film subsequent to the discard glass part are brought into a state of being extremely close to each other immediately after the separating step. In such a state, there may be difficulty in allocating paths of the discard glass part and the subsequent band-shaped glass film so as to cause the discard glass part to leave the horizontal conveyance path and cause the subsequent band-shaped glass film to be conveyed along the horizontal conveyance path. However, when the discard glass part is caused to fall from the horizontal conveyance path, the moving speed of the discard glass part increases along with the falling, and hence the discard glass part moves at a speed higher than that of the subsequent band-shaped glass film. Therefore, a distance between the rearmost portion of the discard glass part and the leading portion of the subsequent band-shaped glass film can be increased, thereby being capable of eliminating the state in which the rearmost portion of the discard glass part and the leading portion of the subsequent band-shaped glass film are close to each other. As a result, such fear can be eliminated, thereby being capable of reliably allocating the paths of the discard glass part and the subsequent band-shaped glass film.

In the method described above, it is preferred that an opening portion which is opened so as to be wider than an entire width of the band-shaped glass film and an opening/closing member configured to open and close the opening portion are provided below the horizontal conveyance path, that the discarding step be performed by opening the opening portion through use of the opening/closing member and allowing the discard glass part to pass through the opening portion, and that the horizontal conveyance step be performed by closing the opening portion through use of the opening/closing member and allowing the band-shaped glass film to pass on the opening/closing member.

In such a manner, the discarding step and the horizontal conveyance step can be switched by only opening and closing the opening portion through use of the opening/closing member. Therefore, an operation which is related to the discarding of the discard glass part can be further simplified.

In the method described above, it is preferred that the opening/closing member comprise: a conveyance surface portion, which is to be opposed to a back surface of the band-shaped glass film when the opening portion is closed; and a jetting port, which is formed in the conveyance surface portion, and configured to jet gas, and that, when the opening portion is closed through use of the opening/closing member, the gas be jetted from the jetting port toward the back surface of the band-shaped glass film passing on the conveyance surface portion so that an effective part which is present at a center of the band-shaped glass film in the width direction is conveyed under a state of floating from the conveyance surface portion.

In such a manner, when the horizontal conveyance step is performed while the opening portion is closed through use of the opening/closing member, formation of, for example, scratches on the effect portion due to contact between the opening/closing member and the effective part of the band-shaped glass film can be avoided as much as possible. With this, with regard to a glass film manufactured with the effective part of the band-shaped glass film, degradation in quality can be prevented.

In the method described above, the entire width of the band-shaped glass film may be conveyed under a state of floating from the conveyance surface portion by jetting of the gas.

In such a manner, contact between the opening/closing member and the band-shaped glass film can be avoided as much as possible. With this, the resistance caused by conveyance of the band-shaped glass film can be reduced as much as possible.

In the method described above, it is preferred that the jetting port comprise: a first jetting port configured to jet the gas toward the effective part; and a second jetting port configured to jet the gas toward non-effective parts which are present on outer sides of the effective part in the width direction, and that a region of the conveyance surface portion in which the first jetting port is formed be separated from the back surface of the band-shaped glass film with respect to a region in which the second jetting port is formed.

As the thickness of the band-shaped glass film becomes smaller, even when the gas is jetted toward the back surface of the band-shaped glass film, the effective part which is present at a center portion in the width direction is more liable to be flexed downward. As a result, due to the contact between the flexed effective part and the conveyance surface portion, for example, scratches are more liable to be formed on the effective part. However, when the region of the conveyance surface portion in which the first jetting port is formed is separated from the back surface of the band-shaped glass film with respect to the region in which the second jetting port is formed, the contact between the effective part and the conveyance surface portion can be avoided as much as possible, thereby being capable of appropriately eliminating such fear described above.

In the method described above, the opening/closing member may comprise a support member configured to support the non-effective parts, which are present on outer sides of the effective part in the width direction, from a lower side when the opening portion is closed.

The non-effective parts of the band-shaped glass film include edge portions each having a thickness larger than those of other parts. Therefore, when the support member configured to support the non-effective parts from the lower side is provided, the edge portions each having a weight larger than those of other parts can be conveyed in a stable state without causing rocking. As a result, the band-shaped glass film can be conveyed in a stable state.

In the method described above, it is preferred that the support member comprise a ball roller.

In such a manner, through use of the ball roller as the support member, an increase in resistance along with conveyance of the band-shaped glass film due to contact between the support member and the non-effective parts can be prevented. Moreover, the ball roller is not limited in its rotation direction. Thus, for example, even when the band-shaped glass film being conveyed is shifted in the width direction, the ball roller can change its rotation direction in accordance with the shifting. Therefore, the band-shaped glass film can be conveyed in a more stable state.

In the method described above, it is preferred that the discard glass part be divided into a plurality of discard glass films and then discarded.

In such a manner, the discard glass part is divided into a plurality of discard glass films and then discarded. Thus, the discard glass part having been discarded can be easily handled.

In the method described above, it is preferred that the band-shaped glass film be cut at a position on the horizontal conveyance path and on downstream of a position of performing the discarding step by laser light in a longitudinal direction along a boundary between the effective part, which is present at the center of the band-shaped glass film in the width direction, and each of the non-effective parts, which are present on outer sides of the effective part in the width direction.

In such a manner, the cutting by laser light is performed on the band-shaped glass film at a position on the horizontal conveyance path and on downstream of the position of performing the discarding step. Thus, occurrence of the situation in which the discard glass part passes through the position of performing the cutting by laser light on the horizontal conveyance path is prevented. With this, inappropriate cutting by laser light on the discarded glass part that is originally not a part subjected to the cutting by laser light can be avoided, thereby being capable of eliminating needless process in manufacture.

### Advantageous Effects of Invention

According to the present invention, in a case of manufacturing the band-shaped glass film in a mode in which the conveyance direction after forming by the down-draw method is changed from the vertically downward direction to the horizontal direction, it is possible to simplify operation for discarding some sections along the longitudinal direction of the band-shaped glass film as a discard glass part. Further, it is possible to prevent formation of a crack in the band-shaped glass film at the time of discarding the discard glass part.

### BRIEF DESCRIPTION OF DRAWINGS

FIG. 1 is a schematic vertical sectional side view for illustrating a method of manufacturing a glass film according to a first embodiment of the present invention.

FIG. 2 is a plan view for illustrating a horizontal conveyance step in the method of manufacturing a glass film according to the first embodiment of the present invention.

FIG. 3 is a vertical sectional front view for illustrating an A-A cross section in FIG. 2.

FIG. 4 is a side view for illustrating the horizontal conveyance step in the method of manufacturing a glass film according to the first embodiment of the present invention.

FIG. 5a is a schematic view for illustrating a separating step and a discarding step in the method of manufacturing a glass film according to the first embodiment of the present invention.

FIG. 5b is a schematic view for illustrating the separating step and the discarding step in the method of manufacturing a glass film according to the first embodiment of the present invention.

FIG. 5c is a schematic view for illustrating the separating step and the discarding step in the method of manufacturing a glass film according to the first embodiment of the present invention.

FIG. 5d is a schematic view for illustrating the separating step and the discarding step in the method of manufacturing a glass film according to the first embodiment of the present invention.

FIG. 6 is a side view for illustrating the separating step and the discarding step in the method of manufacturing a glass film according to the first embodiment of the present invention.

FIG. 7 is a side view for illustrating the separating step and the discarding step in the method of manufacturing a glass film according to the first embodiment of the present invention.

FIG. 8 is a side view for illustrating the separating step and the discarding step in the method of manufacturing a glass film according to the first embodiment of the present invention.

FIG. 9 is a side view for illustrating the method of manufacturing a glass film according to the first embodiment of the present invention.

FIG. 10 is a side view for illustrating the horizontal conveyance step in the method of manufacturing a glass film according to the first embodiment of the present invention.

FIG. 11 is a plan view for illustrating a horizontal conveyance step in a method of manufacturing a glass film according to a second embodiment of the present invention.

FIG. 12 is a vertical sectional front view for illustrating the horizontal conveyance step in the method of manufacturing a glass film according to the second embodiment of the present invention.

FIG. 13 is a plan view for illustrating a horizontal conveyance step in a method of manufacturing a glass film according to a third embodiment of the present invention.

FIG. 14 is a vertical sectional front view for illustrating the horizontal conveyance step in the method of manufacturing a glass film according to the third embodiment of the present invention.

FIG. 15 is a plan view for illustrating a horizontal conveyance step in a method of manufacturing a glass film according to a fourth embodiment of the present invention.

FIG. 16 is a vertical sectional front view for illustrating the horizontal conveyance step in the method of manufacturing a glass film according to the fourth embodiment of the present invention.

### DESCRIPTION OF EMBODIMENTS

Now, with reference to the accompanying drawings, description is made of a method of manufacturing a glass film according to embodiments of the present invention.

### First Embodiment

First, description is made of a method of manufacturing a glass film according to a first embodiment of the present invention. It is preferred that this embodiment be applied to a case in which a band-shaped glass film to be formed has a thickness of less than 50 μm.

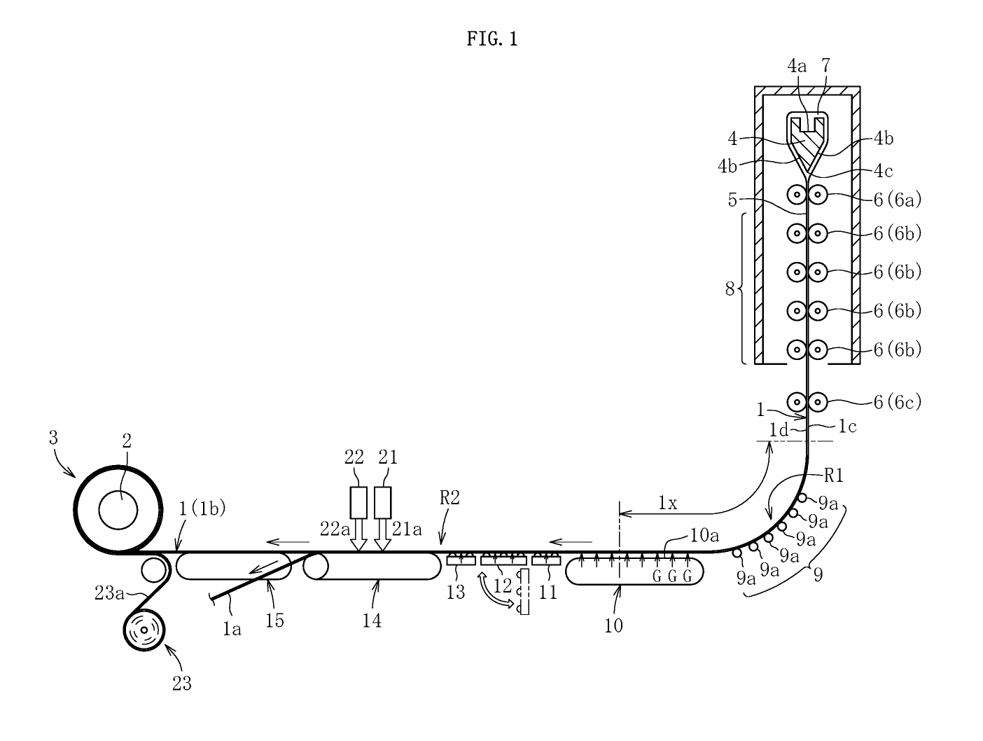

As illustrated in FIG. 1, the method of manufacturing a glass film according to the first embodiment comprises a forming step, a conveyance direction changing step, a horizontal conveyance step, a cutting and removing step, and a winding step. In the forming step, a band-shaped glass film 1 is formed while being drawn downward in a vertical direction by an overflow down-draw method. In the conveyance direction changing step, a conveyance direction of the band-shaped glass film 1 is changed from a vertically downward direction to a horizontal direction by conveying the formed band-shaped glass film 1 along a curved conveyance path R1. In the horizontal conveyance step, the band-shaped glass film 1, which has been changed in conveyance direction, is conveyed in the horizontal direction along a horizontal conveyance path R2. In the cutting and removing step, non-effective parts 1a are cut and removed from the band-shaped glass film 1 being conveyed in the horizontal direction. In the winding step, the band-shaped glass film 1 having the non-effective parts 1a removed therefrom and comprising only an effective part 1b is wound up into a roll around a winding core 2 to be formed into a glass roll 3.

[Forming Step]

For the forming step, there are mainly used a forming trough 4 and roller pairs 6. The forming trough 4 has a wedge shape. The roller pairs 6 are arranged in a plurality of stages along an up-and-down direction, and are capable of sandwiching, from both front and back sides, a glass ribbon 5 flowing down from the forming trough 4.

The forming trough 4 comprises an overflow groove 4a, a pair of side surface portions 4b and 4b, and a lower end portion 4c. The overflow groove 4a is formed in a top portion of the forming trough 4 for allowing a molten glass 7 to flow thereinto. The pair of side surface portions 4b and 4b are configured to allow the molten glass 7 having flowed out from the overflow groove 4a to both sides to flow down. The lower end portion 4c is configured to merge and integrate the molten glass 7 having flowed down along the side surface portions 4b and 4b. The forming trough 4 is capable of continuously producing the glass ribbon 5 from the molten glass 7 having merged and integrated at the lower end portion 4c.

The roller pairs 6 arranged in a plurality of stages along the up-and-down direction comprise a cooling roller pair 6a, annealer roller pairs 6b, and a support roller pair 6c in the state order from an upper stage. The roller pairs 6 are each capable of sandwiching parts of the glass ribbon 5 on one side and another side in a width direction of the glass ribbon 5, which are to be later formed into the non-effective parts la of the band-shaped glass film 1.

The cooling roller pair 6a is a roller pair configured to suppress contraction of the glass ribbon 5 in the width direction by sandwiching the glass ribbon 5 directly below the forming trough 4. The annealer roller pairs 6b are each a roller pair configured to guide the glass ribbon 5 downward, which is to be annealed to a temperature equal to or less than a strain point in an annealing furnace 8. The annealer roller pairs 6b sandwich the glass ribbon 5 in some cases, or only restrict rocking of the glass ribbon 5 in the thickness direction without sandwiching the glass ribbon 5 in some cases. The support roller pair 6c is a roller pair which is configured to support the glass ribbon 5 having been reduced in temperature to a temperature close to a room temperature in a cooling chamber (not shown) arranged below the annealing furnace 8. Further, the support roller pair 6c is configured to determine a speed of pulling down the glass ribbon 5 (drawing speed).

The glass ribbon 5 having passed through the roller pairs 6 which are arranged in a plurality of stages along the up-and-down direction is formed into the band-shaped glass film 1. The band-shaped glass film 1 is formed so as to have a thickness which is sufficient to give flexibility to the band-shaped glass film 1. The band-shaped glass film 1 comprises the effective part 1b and the pair of non-effective parts 1a. The effective part 1b is present at a center in the width direction (direction perpendicular to the drawing sheet of FIG. 1) and later forms a finished product. The pair of non-effective parts 1a are present on outer sides of the effective part 1b in the width direction and are to be removed. Further, in the non-effective parts 1a, at parts positioned at end portions of the band-shaped glass film 1 in the width direction, there are formed edge portions 1aa each having a thickness larger than those of other parts.

In this embodiment, the band-shaped glass film 1 is formed through use of the overflow down-draw method. However, as a matter of course, the band-shaped glass film 1 may be formed through use of, for example, a slot down-draw method or a re-draw method.

[Conveyance Direction Changing Step]

For the conveyance direction changing step, a roller conveyor 9 is used. The roller conveyor 9 is formed of a plurality of rollers 9a arranged in parallel with each other. The roller conveyor 9 conveys the band-shaped glass film 1 along the curved conveyance path R1 while supporting the band-shaped glass film 1 from a back surface 1c side, to thereby change the conveyance direction so that a front surface 1d of the band-shaped glass film 1 having passed through the curved conveyance path R1 faces upward.

[Horizontal Conveyance Step]

For the horizontal conveyance step, there are used a belt conveyor 10, three divided plate-shaped bodies 11, 12, and 13, a belt conveyor 14, and a belt conveyor 15, which are arranged in the stated order from an upstream side along the horizontal conveyance path R2.

The belt conveyor 10 is capable of jetting a gas G (for example, air) with respect to the back surface 1c of the band-shaped glass film 1, and the band-shaped glass film 1 is conveyed on the belt conveyor 10 under a state in which only a center thereof in the width direction (mainly the effective part 1b) floats. The belt conveyor 10 comprises a belt 10a and a gas jetting device (not shown). The belt 10a has an endless shape, and is configured to convey non-floating portions (mainly the non-effective parts 1a) of the band-shaped glass film 1. The gas jetting device is arranged on an inner peripheral side of the belt 10a, and is configured to jet the gas G upward. The belt 10a has a large number of fine through holes (not shown), and the gas G having been jetted from the gas jetting device passes through the through holes to reach the back surface 1c of the band-shaped glass film 1. The gas jetting device arranged on the inner peripheral side of the belt 10a is arranged along the center of the belt 10a in the width direction.

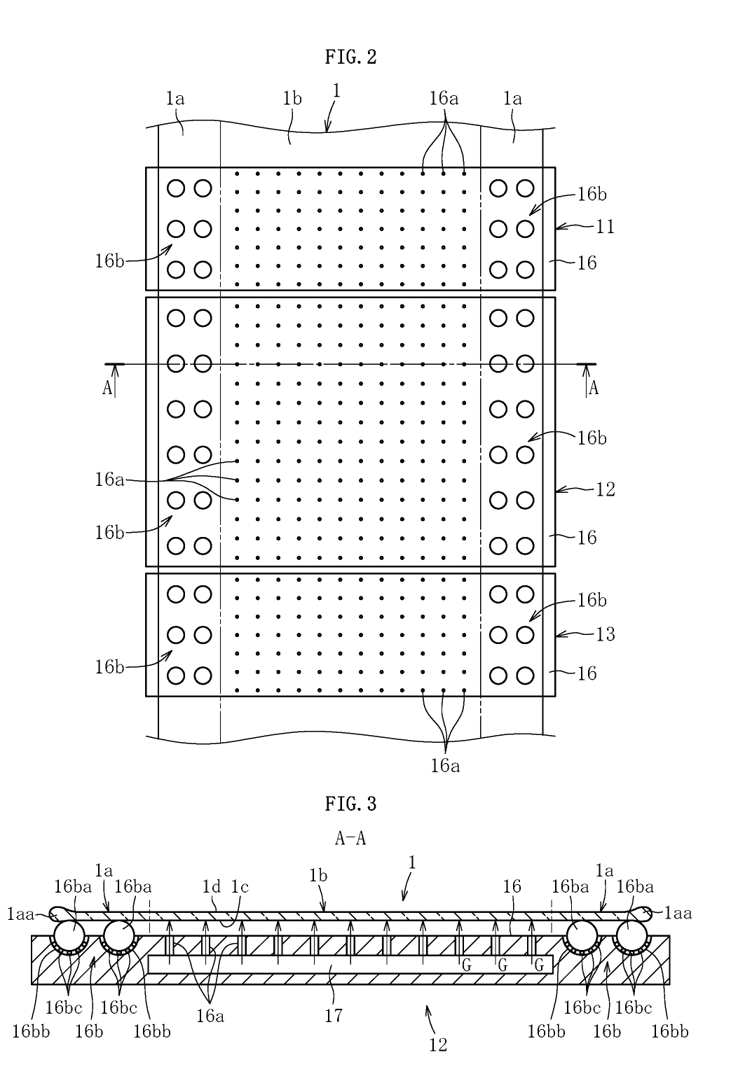

As illustrated in FIG. 2 and FIG. 3, the three divided plate-shaped bodies 11, 12, and 13 each comprise a conveyance surface portion 16 to be opposed to the back surface 1c of the band-shaped glass film 1. The conveyance surface portion 16 has a large number of jetting ports 16a. The jetting ports 16a are configured to jet the gas G (for example, air) toward the effective part 1b of the band-shaped glass film 1 passing on the conveyance surface portion 16. Moreover, the conveyance surface portion 16 comprises a plurality of ball rollers 16b serving as a support member configured to support the non-effective parts 1a of the band-shaped glass film 1 from a lower side. With this, during the horizontal conveyance step, under a state in which the effective part 1b floats from the conveyance surface portion 16 by the pressure of the gas G and in which the non-effective parts 1a are supported by the ball rollers 16b, the band-shaped glass film 1 is conveyed so as to pass on the plate-shaped bodies 11, 12, and 13.

The conveyance surface portion 16 is formed into a rectangular shape which is wider than an entire width of the band-shaped glass film 1. The large number of jetting ports 16a communicate with a space 17 defined inside each of the plate-shaped bodies 11, 12, and 13. The jetting ports 16a are each capable of jetting the gas G, which is supplied from a fluid compressing device (for example, an air compressor) to the space 17. The plurality of ball rollers 16b are arranged in a state of being arrayed in two rows along the longitudinal direction of the band-shaped glass film 1. The ball rollers 16b each comprise a load ball 16ba, a hole portion 16bb, and support balls 16bc. The load ball 16ba has a spherical shape, and is configured to directly support the non-effective part 1a. The hole portion 16bb is configured to receive the load ball 16ba inserted thereinto. The support balls 16bc are configured to support the load ball 16ba so that the load ball 16ba is rotatable in the hole portion 16bb.

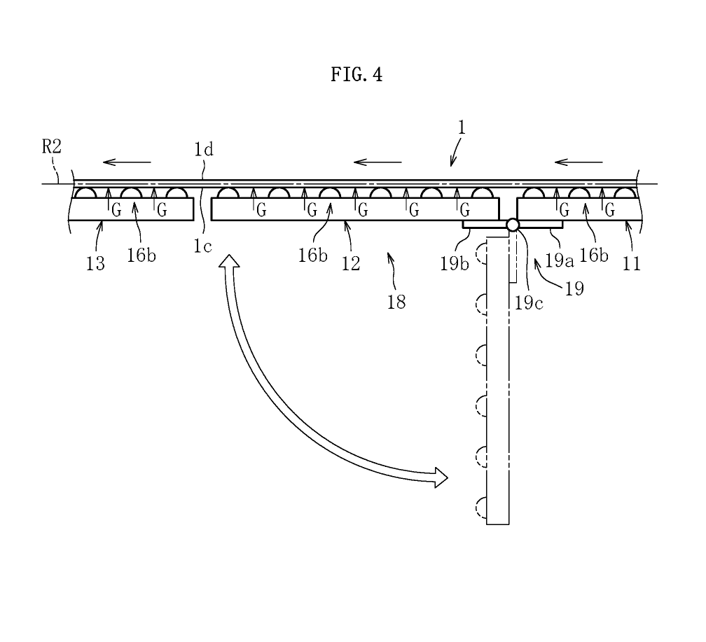

As illustrated in FIG. 4, among the three divided plate-shaped bodies 11, 12, and 13, the plate-shaped body 12 serves as an opening/closing member configured to open and close an opening portion 18 defined between the plate-shaped body 11 and the plate-shaped body 13. The opening portion 18 is defined below the horizontal conveyance path R2, and is opened so as to be wider than the entire width of the band-shaped glass film. The plate-shaped body 12 is connected to the plate-shaped body 11, which is arranged on upstream of the plate-shaped body 12 along the horizontal conveyance path R2, through intermediation of a coupling member 19 (for example, a hinge). The coupling member 19 comprises a first plate 19a, a second plate 19b, and a shaft portion 19c. The first plate 19a is fixed to the plate-shaped body 11. The second plate 19b is fixed to the plate-shaped body 12. The shaft portion 19c is configured to hold both the plates 19a and 19b and serves as a swing shaft for the plates 19a and 19b. The shaft portion 19c extends along the width direction of the band-shaped glass film 1.

With this configuration, the plate-shaped body 12 swings about the shaft portion 19c of the coupling member 19 so as to be movable between an initial position (position indicated by the solid line in FIG. 4) and a swing position (position indicated by the two-dot chain line in FIG. 4), thereby opening and closing the opening portion 18 along with the movement. In the method of manufacturing a glass film according to this embodiment, through the opening and closing of the opening portion 18 by the plate-shaped body 12, the operation of the horizontal conveyance step and an operation including a separating step and a discarding step, which are described later, can be switched.

When the plate-shaped body 12 is brought to the initial position to close the opening portion 18, as described above, under the state in which the effective part 1b floats by the gas G and the non-effective parts 1a are supported by the ball rollers 16b, the band-shaped glass film 1 is allowed to pass on the plate-shaped body 12 so that the horizontal conveyance step is performed. In contrast, when the plate-shaped body 12 is brought to the swing position to open the opening portion 18, under a state in which jetting of the gas G and the support by the ball rollers 16b are cancelled, the separating step and the discarding step are performed.

[Separating Step and Discarding Step]

Now, description is made of an outline of the separating step and the discarding step.

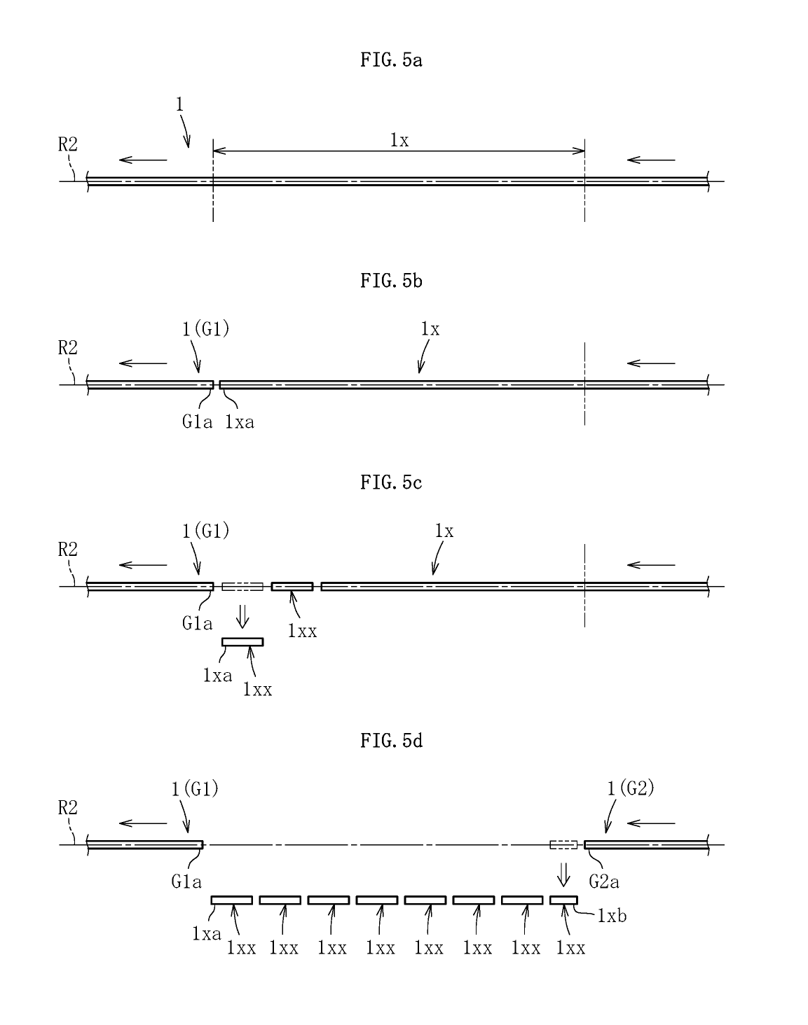

In FIG. 5a to FIG. 5d, illustration is given of an outline of the separating step and the discarding step. A leading portion 1xa of a discard glass part 1x illustrated in FIG. 5a is first separated from a rearmost portion G1a of a preceding band-shaped glass film 1 (G1) as illustrated in FIG. 5b. With this, the separating step is started. After that, as illustrated in FIG. 5c, the discard glass part 1x is continuously divided into a plurality of discard glass films 1xx. Moreover, along with the start of the discarding step, the discard glass films 1xx are sequentially caused to leave the horizontal conveyance path R2 downward so that the discard glass films 1xx are discarded. Finally, as illustrated in FIG. 5d, a rearmost portion 1xb of the discard glass part 1x is separated from a leading portion G2a of a subsequent band-shaped glass film 1 (G2). With this, the entire length of the discard glass part 1x is separated from the band-shaped glass film 1, and the separating step is completed. Moreover, the discard glass film 1xx including the rearmost portion 1xb of the discard glass part 1x is discarded, and the discarding step is completed.

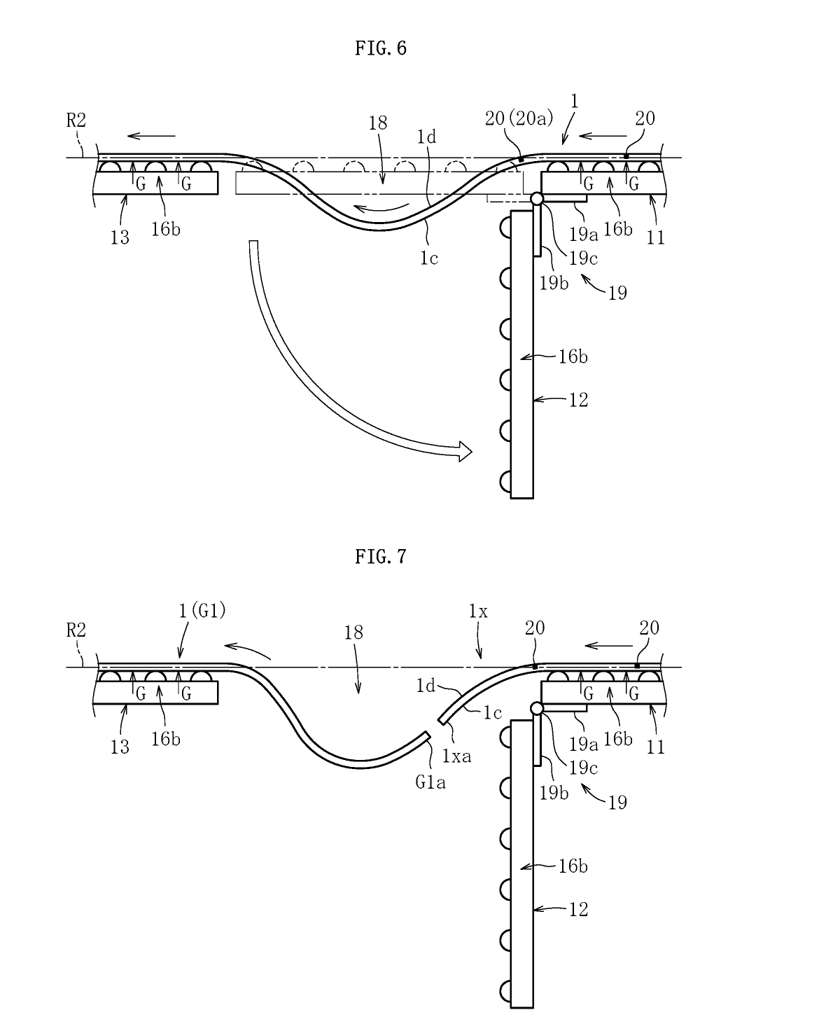

Now, with reference to FIG. 6 to FIG. 8, detailed description is made of the separating step and the discarding step.

First, as a preparation for the separating step and the discarding step, a cutting start point 20 serving as a start point for cutting is formed on the front surface 1d side of the band-shaped glass film 1. The cutting start point 20 is formed at a position on upstream of the plate-shaped body 12 on the conveyance path for the band-shaped glass film 1. The position of forming the cutting start point 20 may be on the horizontal conveyance path R2, or may be on the curved conveyance path R1. Moreover, the cutting start point 20 may be, for example, a scribe line formed along the width direction of the band-shaped glass film 1 through use of a wheel cutter, or a scratch formed in the edge portion 1aa of the band-shaped glass film 1 along the width direction through use of a grinder. A plurality of cutting start points 20 are successively formed at intervals along the longitudinal direction of the band-shaped glass film 1.

Next, as illustrated in FIG. 6, when a cutting start point 20 (20a) which is positioned on most downstream on the horizontal conveyance path R2 among the plurality of cutting start points 20 reaches the plate-shaped body 12, the plate-shaped body 12 is moved from the initial position to the swing position to open the opening portion 18. In this embodiment, the opening portion 18 is opened after the cutting start point 20 (20a) has reached the plate-shaped body 12. However, the opening portion 18 may be opened before the cutting start point 20 (20a) reaches the plate-shaped body 12. With this, the band-shaped glass film 1 stretched between the plate-shaped body 11 and the plate-shaped body 13 is flexed downward by its own weight. Then, along with this flexure, the portion at which the cutting start point 20 (20a) is formed is curved so that the front surface 1d side thereof protrudes. With this, as illustrated in FIG. 7, the band-shaped glass film 1 is cut in the width direction by bending stress with the cutting start point 20 (20a) as a start point. Then, along with the cutting of the band-shaped glass film 1, the leading portion 1xa of the discard glass part 1x is separated from the rearmost portion G1a of the preceding band-shaped glass film 1 (G1).

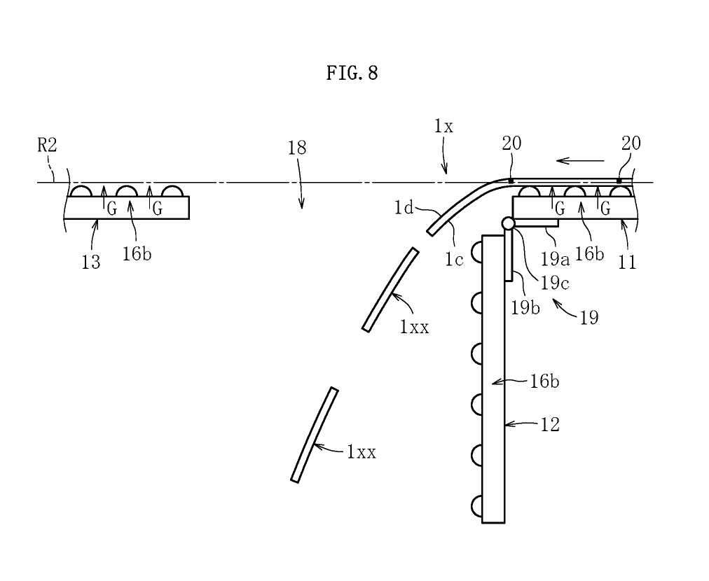

After the band-shaped glass film 1 has been cut with the cutting start point 20 (20a) as a start point, every time each of the plurality of cutting start points 20 subsequent to the cutting start point 20 (20a) reaches the opening portion 18 having already been opened, the discard glass part 1x is repeatedly cut in the width direction with the cutting start points 20 as start points. Along with this action, as illustrated in FIG. 8, the discard glass part 1x is divided into a plurality of discard glass films 1xx, and the discard glass films 1xx are caused to fall from the horizontal conveyance path R2 and pass through the opening portion 18, thereby discarding the discard glass films 1xx. The discarding of the discard glass films 1xx is continuously performed until the discard glass film 1xx including the rearmost portion 1xb of the discard glass part 1x is discarded. With the operations described above, the separating step and the discarding step are completed.

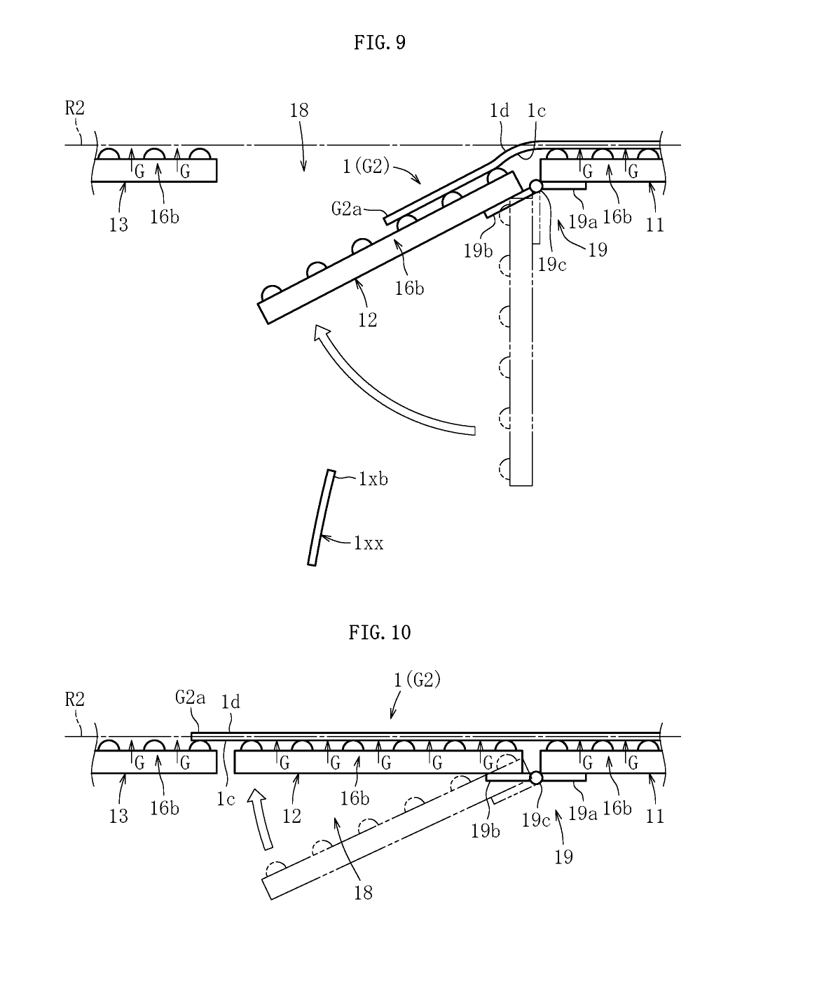

After the separating step and the discarding step have been completed, as illustrated in FIG. 9, at the time point at which the leading portion G2a of the band-shaped glass film 1 (G2) connected to the rearmost portion 1xb of the discard glass part 1x reaches the plate-shaped body 12, the plate-shaped body 12 is moved to return from the swing position to the initial position, and closing of the opening portion 18 is started. After the plate-shaped body 12 returns to the initial position, the opening portion 18 is closed by the plate-shaped body 12 by the returning of the plate-shaped body 12. Then, as illustrated in FIG. 10, the horizontal conveyance step of conveying the band-shaped glass film 1 (G2) which is subsequent to the discard glass part 1x along the horizontal conveyance path R2 is performed.

[Cutting and Removing Step]

As illustrated in FIG. 1, in the cutting and removing step, at a position on the horizontal conveyance path R2 and on downstream of the position of performing the discarding step, the non-effective parts la are cut and removed from the band-shaped glass film 1 through use of a laser cutting method. For the cutting and removing step, there are used a laser irradiator 21 and a refrigerant jetting device 22, which are fixed and installed at certain points above the belt conveyor 14. The laser irradiator 21 is configured to continuously irradiate the band-shaped glass film 1 passing therebelow with a laser light 21a along a boundary between the effective part 1b and each of the non-effective parts 1a. The refrigerant jetting device 22 is configured to continuously jet a refrigerant 22a (for example, mist-like water) with respect to the part of the band-shaped glass film 1 having been irradiated with the laser light 21a.

With this, a thermal stress is generated in the band-shaped glass film 1 due to a temperature difference between the part having been heated by the laser light 21a and the part having been cooled by the refrigerant 22a. Further, due to the thermal stress, a cut part (part at which the effective part 1b and the non-effective part 1a are separated from each other) is continuously formed along the boundary between the effective part 1b and the non-effective part 1a. In such a manner, the band-shaped glass film 1 is continuously cut along the longitudinal direction. In this embodiment, the band-shaped glass film 1 is cut by the laser cutting method. However, the band-shaped glass film 1 may be cut by a laser fusing method, or a so-called “peeling method” of simultaneously performing laser fusion and removal of an end portion formed along with the fusion as a string-shaped object to be peeled off.

The band-shaped glass film 1 having the non-effective parts 1a cut and removed therefrom (band-shaped glass film 1 comprising only the effective part 1b) is moved from the belt conveyor 14 to the belt conveyor 15. Meanwhile, the non-effective parts 1a having been removed from the band-shaped glass film 1 are not moved to the belt conveyor 15. The non-effective parts 1a are separated downward from the conveyance path for the band-shaped glass film 1, and are thereafter discarded.

[Winding Step]

For the winding step, there are mainly used the winding core 2 and a sheet roll 23. In the winding step, the band-shaped glass film 1 having been conveyed from the belt conveyor 15 is superposed on a protection sheet 23a that is continuously fed out from the sheet roll 23. After that, the band-shaped glass film 1 is wound up into a roll around the winding core 2 to be formed into the glass roll 3. With this, all of the steps of the method of manufacturing a glass film according to this embodiment are completed.

Now, description is made of a method of manufacturing a glass film according to another embodiment of the present invention. In the description of the another embodiment, components which are already described in the above-mentioned first embodiment are denoted by the same reference symbols in the drawings referred to in the description of the another embodiment. Thus, redundant description thereof is omitted, and only differences from the first embodiment are described. In second to fourth embodiments described below, respective methods of manufacturing a glass film are different from that of the above-mentioned first embodiment in that the configuration of the plate-shaped bodies 11, 12, and 13 is different.

### Second Embodiment

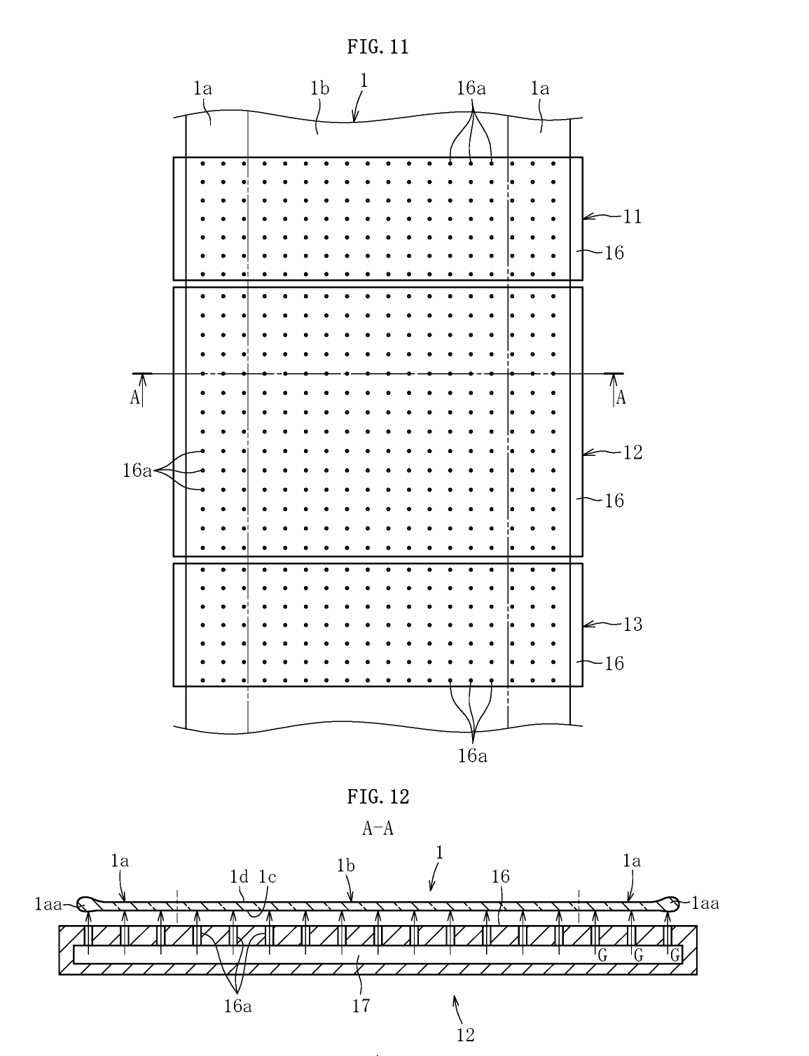

As illustrated in FIG. 11 and FIG. 12, in the method of manufacturing a glass film according to the second embodiment, in the conveyance surface portion 16 of each of the plate-shaped bodies 11, 12, and 13, a large number of jetting ports 16a which are configured to jet the gas G toward the non-effective parts 1a of the band-shaped glass film 1 are formed in the region in which the plurality of ball rollers 16b are provided in the above-mentioned first embodiment. With this, in this embodiment, during the horizontal conveyance step, under a state in which the entire width of the band-shaped glass film 1 floats from the conveyance surface portion 16 by the pressure of the gas G, the band-shaped glass film 1 is conveyed so as to pass on the plate-shaped bodies 11, 12, and 13. It is preferred that this embodiment be applied to the case in which, similarly to the above-mentioned first embodiment, the band-shaped glass film 1 to be formed has a thickness of less than 50 μm.

### Third Embodiment

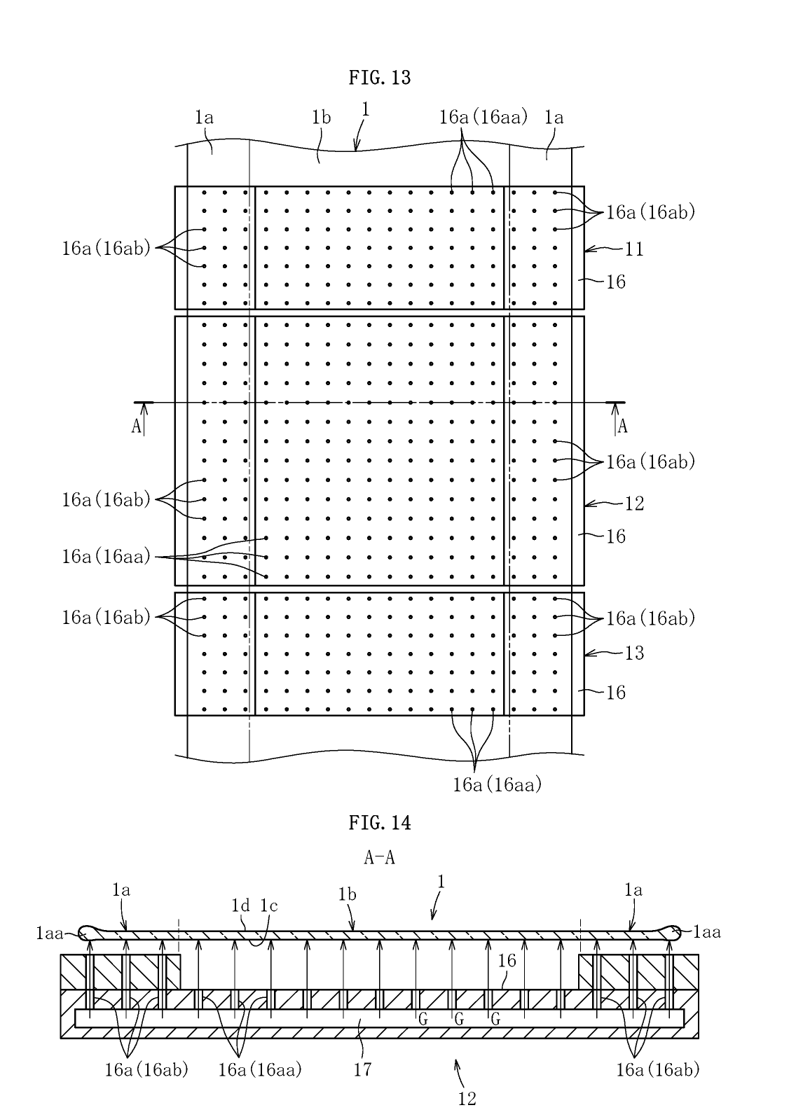

As illustrated in FIG. 13 and FIG. 14, in the method of manufacturing a glass film according to the third embodiment, in the conveyance surface portion 16 of each of the plate-shaped bodies 11, 12, and 13, first jetting ports 16aa configured to jet the gas G toward the effective part 1b and second jetting ports 16ab configured to jet the gas G toward the non-effective parts 1a are formed. Further, in the conveyance surface portion 16, the region in which the first jetting ports 16aa are formed is arranged so as to be separated from the back surface of the band-shaped glass film with respect to the region in which the second jetting ports 16ab are formed. With this, in this embodiment, during the horizontal conveyance step, under the state in which the entire width of the band-shaped glass film 1 floats from the conveyance surface portion 16 by the pressure of the gas G and in which the effective part 1b is separated from the conveyance surface portion 16 with respect to the non-effective parts 1a, the band-shaped glass film 1 is conveyed so as to pass on the plate-shaped bodies 11, 12, and 13. It is preferred that this embodiment be applied to the case in which the band-shaped glass film 1 to be formed has a thickness equal to or more than 50 μm.

### Fourth Embodiment

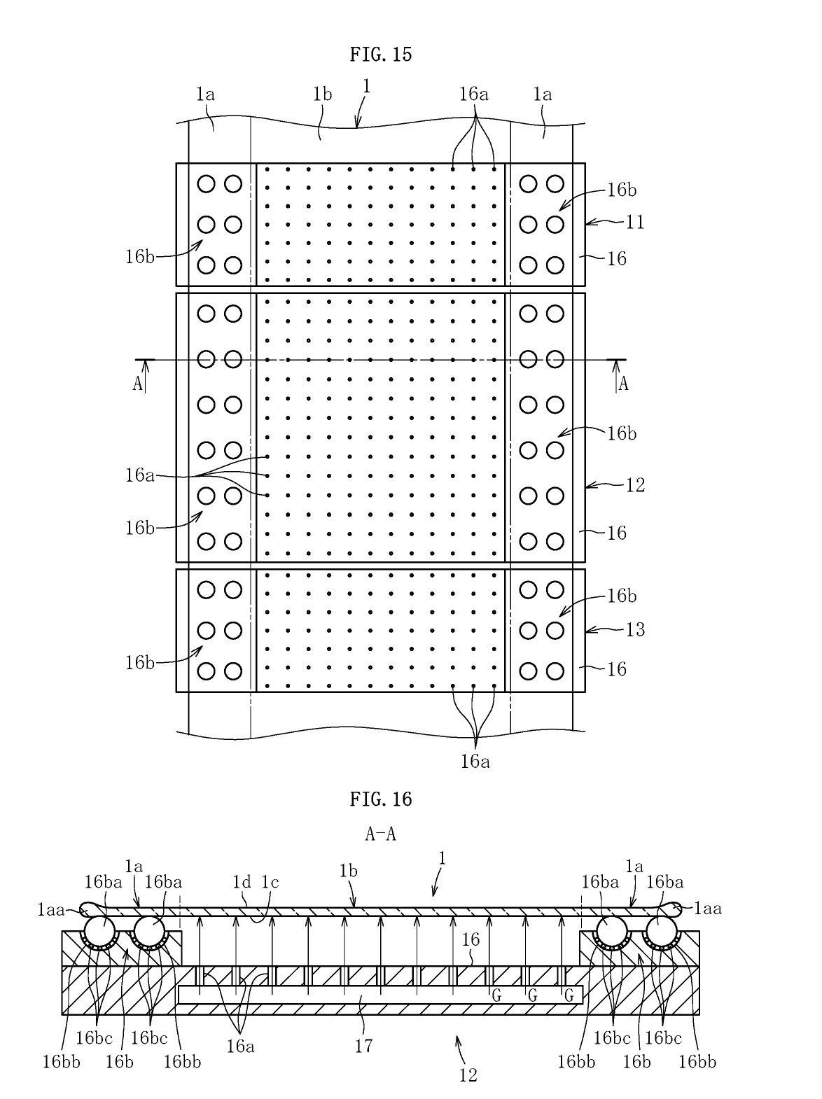

As illustrated in FIG. 15 and FIG. 16, in the method of manufacturing a glass film according to the fourth embodiment, in the conveyance surface portion 16 of each of the plate-shaped bodies 11, 12, and 13, the region in which the plurality of ball rollers 16b are provided is arranged above the region in which the large number of jetting ports 16a are formed. With this, in this embodiment, during the horizontal conveyance step, under the state in which the effective part 1b floats further above the conveyance surface portion 16 by the pressure of the gas G in comparison with the above-mentioned first embodiment and in which the non-effective parts 1a are supported by the ball rollers 16b, the band-shaped glass film 1 is conveyed so as to pass on the plate-shaped bodies 11, 12, and 13. It is preferred that this embodiment be applied to the case in which the band-shaped glass film 1 to be formed has a thickness equal to or more than 50 μm.

A method of manufacturing a glass film according to the present invention is not limited to the modes described in the above-mentioned embodiments. For example, in each of the above-mentioned embodiments, the plate-shaped body 12 is used as the opening/closing member configured to open and close the opening portion 18. However, a belt conveyor may be used as the opening/closing member. In this case, for example, in order to perform the horizontal conveyance step under a state in which a conveyance surface of the belt conveyor is in a posture along a horizontal plane (conveyance surface of the belt conveyor is in a posture of being parallel to the horizontal direction) and perform the separating step and the discarding step under a state in which the conveyance surface is in a posture of an inclined plane that is inclined with respect to the horizontal plane, a belt conveyor which is capable of being changed in posture is used.

Moreover, in each of the above-mentioned embodiments, the roller conveyor 9 is used for the conveyance direction changing step, but the present invention is not limited to this configuration. The conveyance direction changing step may be performed without use of the roller conveyor 9, and may be performed by conveying the band-shaped glass film, which is being conveyed downward in the vertical direction, directly to the belt conveyor 10 (horizontal conveyance path R2). In this case, the band-shaped glass film on the curved conveyance path R1 is brought into a state of being curved in conformity with the curved conveyance path R1 under a state of not being supported by any external object.

### REFERENCE SIGNS LIST

1 band-shaped glass film
1a non-effective part
1b effective part
1c back surface
1d front surface
1x discard glass part
1xx discard glass film
12 plate-shaped body
16 conveyance surface portion
16a jetting port
16aa first jetting port
16ab second jetting port
16b ball roller
18 opening portion
G gas
R1 curved conveyance path
R2 horizontal conveyance path

1. A method of manufacturing a glass film, comprising:
a forming step of forming a band-shaped glass film by drawing the band-shaped glass film downward in a vertical direction by a down-draw method;
a conveyance direction changing step of changing a conveyance direction of the band-shaped glass film from a vertically downward direction to a horizontal direction by conveying the formed band-shaped glass film along a curved conveyance path so that a front surface of the band-shaped glass film after having passed through the curved conveyance path faces upward; and
a horizontal conveyance step of conveying the band-shaped glass film, which has been changed in conveyance direction, in the horizontal direction along a horizontal conveyance path,
wherein, when some sections of the band-shaped glass film along a longitudinal direction are to be discarded as a discard glass part, the method involves:
a separating step of separating the discard glass part from the band-shaped glass film by cutting the band-shaped glass film in a width direction on the horizontal conveyance path; and
a discarding step of discarding the separated discard glass part by causing the discard glass part to leave the horizontal conveyance path downward.

2. The method of manufacturing a glass film according to claim 1,
wherein an opening portion which is opened so as to be wider than an entire width of the band-shaped glass film and an opening/closing member configured to open and close the opening portion are provided below the horizontal conveyance path,
wherein the discarding step is performed by opening the opening portion through use of the opening/closing member and allowing the discard glass part to pass through the opening portion, and
wherein the horizontal conveyance step is performed by closing the opening portion through use of the opening/closing member and allowing the band-shaped glass film to pass on the opening/closing member.

3. The method of manufacturing a glass film according to claim 2,
wherein the opening/closing member comprises:
a conveyance surface portion, which is to be opposed to a back surface of the band-shaped glass film when the opening portion is closed; and
a jetting port, which is formed in the conveyance surface portion, and configured to jet gas, and
wherein, when the opening portion is closed through use of the opening/closing member, the gas is jetted from the jetting port toward the back surface of the band-shaped glass film passing on the conveyance surface portion so that an effective part which is present at a center of the band-shaped glass film in the width direction is conveyed under a state of floating from the conveyance surface portion.

4. The method of manufacturing a glass film according to claim 3, wherein the entire width of the band-shaped glass film is conveyed under a state of floating from the conveyance surface portion by jetting of the gas.

5. The method of manufacturing a glass film according to claim 4,
wherein the jetting port comprises:
a first jetting port configured to jet the gas toward the effective part; and
a second jetting port configured to jet the gas toward non-effective parts which are present on outer sides of the effective part in the width direction, and
wherein a region of the conveyance surface portion in which the first jetting port is formed is separated from the back surface of the band-shaped glass film with respect to a region in which the second jetting port is formed.

6. The method of manufacturing a glass film according to claim 3, wherein the opening/closing member comprises a support member configured to support the non-effective parts, which are present on outer sides of the effective part in the width direction, from a lower side when the opening portion is closed.

7. The method of manufacturing a glass film according to claim 6, wherein the support member comprises a ball roller.

8. The method of manufacturing a glass film according to claim 1, wherein, in the discarding step, the discard glass part is divided into a plurality of discard glass films and then discarded.

9. The method of manufacturing a glass film according to claim 1, wherein the band-shaped glass film is cut at a position on the horizontal conveyance path and on downstream of a position of performing the discarding step by laser light in a longitudinal direction along a boundary between the effective part, which is present at the center of the band-shaped glass film in the width direction, and each of the non-effective parts, which are present on outer sides of the effective part in the width direction.
